(19) United States
(12) Patent Application Publication
(10) Pub. No.: US 2003/0009845 A1
(43) Pub. Date: Jan. 16, 2003

(54) Door catch for sliding doors of motor vehicles

(75) Inventor: Thomas Kindermann, Remscheid (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Edscha AG, Remscheid (DE)

(21) Appl. No.: 10/185,668

(22) Filed: Jun. 28, 2002

(30) Foreign Application Priority Data
Jul. 12, 2001 (DE) 101 33 938.0

(51) Int. Cl. E05F 3/00

(52) U.S. Cl. 16/49

(57) ABSTRACT

A door catch for a sliding door of a motor vehicle includes a holding arm, with the holding arm being secured on a running rail of the sliding door using a holder and being pivotable against a preloaded spring. The catch has a latching member, the latching member being a nose which is arranged on the holding arm, and a counter-latching member, the counter-latching member being a latching cam which is acting transversely to the direction of travel of the sliding door. In the open position of the door, the holding arm latches, through said latching member, with said counter-latching member.

Priority to German Patent Application No. 101 33 938.0, filed Jul. 12, 2001 and hereby incorporated by reference herein, is claimed.

### BACKGROUND INFORMATION

The present invention relates to a door catch for sliding doors of motor vehicles, with a holding arm, which is secured on the running rail of the sliding door using a holder, can be pivoted against a preloaded spring and, in the open position of the sliding door, latches using a latching member with a counter-latching member arranged on the sliding door.

There are special requirements of door catches for sliding doors on vehicles: first of all, they should hold the sliding door in the open position with defined entry and withdrawal forces. At the same time, the sliding door should be held securely even when the vehicle is standing in an unfavorable way, e.g. at an angle, to exclude the possibility of accidents, especially due to sliding doors rolling back into the closed position. The actuating force for complete opening, on the one hand, and that for the return to the closed position, on the other hand, should furthermore not be too high in order to ensure that the sliding door can be actuated even by people of average strength without great effort.

To date, there is a door catch of the type stated at the outset that comprises a single-armed pivotable lever that is preloaded against a holder using a leg spring. As a latching member, the lever comprises a rotatable latching roller, which is mounted perpendicularly to the direction of travel of the sliding door. The holder is secured on the rear side of a running rail of the sliding door in such a way that the latching roller projects through a slot on the front side of the running rail and, in the open position of the sliding door, can engage between two running rollers of a traveling carriage of the sliding door, which are guided in the running rail and are mounted perpendicularly. The running rollers thus serve as counter-latching members.

This door catch imposes severe loading on the bearings of the running rollers of the traveling carriage, owing namely to the very high spring force of the leg spring due to the preloading, it being necessary for this spring force to be sufficiently high to bring about an adequate, safe holding force for the open sliding door. With the spring fully loaded, the spring force is 375 newtons in one application. Under this heavy and shock-type loading, the life of the running rollers is short, especially when the doors are opened very often and the door catch is consequently used very often, as is the case, for example, with commercial use of buses, delivery vehicles and the like. Moreover, assembly is difficult since it must take place from the rear side of the running rail and, for this purpose, requires an opening in the running rail, at least for the latching roller.

French Patent Document No. 21 47 567 discloses a sliding-roof actuation system in which a latching member of the actuating system in the form of a latching hook is locked with a latching pin on the body in the closed position of the sliding roof.

U.S. Pat. No. 1,596,411 discloses a stopper for a vertically displaceable window, which prevents the upper part of the window from sliding down. For this purpose, the stopper comes to rest in frictional engagement on the frame of the upper part of the window.

European Patent Application No. 0 791 709 A2 discloses a door catch for sliding doors, in which a latching member is designed as a fork and the counter-latching member is designed as a pin. A door catch of this kind is complex and consequently expensive to produce. Moreover, it has little capacity for adaptation to the wishes of the user.

German Patent Document No. 74 38 035 U discloses a door catch for pivotably fixed motor-vehicle doors. The corresponding extension arm is guided on all sides in a slot in the housing, and arranged on the extension arm is a latching cam, which interacts with a resilient nose in the housing.

U.S. Pat. No. 3,051,983 discloses a door catch for pivotable doors of motor vehicles. Ramp-type resilient members can interact on the corresponding fixing arm with limiting cams of a through opening.

### SUMMARY OF THE INVENTION

An object of the present invention is to provide a door catch that can be fitted easily and independently of the running mechanism of the sliding door.

This and further objects are achieved by the present invention.

According to the present invention, a nose is arranged as a latching member on the holding arm and a latching cam acting transversely to the direction of travel of the sliding door is arranged as a counter-latching member. When the sliding door is fully opened, the latching cam actuates the holding arm of the door catch, with the holding arm yielding briefly and then locking the latching cam and hence the sliding door in the end position, the open position.

The present invention is completely independent of the arrangement of any running mechanism, such as running rollers. Consequently, running rollers and their bearings that are present are not subjected to loading. The door catch can be fitted easily since there are various fitting options: the direction of force of the system, i.e. of the lever, can be either perpendicular or horizontal relative to the direction of travel of the sliding door, for example relative to a running rail of the sliding door. A compression spring or a leg spring can be used, depending on space conditions. In contrast to the known latching roller, however, both the latching cam and the nose can have different shapes, in particular cross-sectional profiles, making it possible to vary the operation of the door catch very widely and hence meet very different customer requirements, whether as regards the actuating force, the actuating travel or the holding force. The actuating force, the entry or withdrawal force respectively required on the sliding door is kept low. The overall mechanism required, especially the spring-loaded holding arm, can be made compact, in particular short, and hence economical in terms of space and materials, and can be mounted easily from the front, from the outside of the body. The latching cam is secured on the sliding door at a suitable location, preferably on a traveling carriage, which is usually present, or on a traveling-carriage arm carrying the latter.

In a preferred embodiment, the nose has two ramps and a tip situated between them. Through use of the ramps, a largely uniform and jerk-free motion is obtained, having the effect of braking the door. This gentle transition can be further assisted by the fact that the tip is rounded in the direction of the ramps.

If the tip is also rounded transversely to the direction of travel, even a slight angular offset of the latching members, nose and latching cam involved does not impair the latching function. To this extent, large dimensional tolerances can be provided for the fitting of the latching members or the holders carrying them, and adjustment or readjustment work can be completely eliminated. To make both the abovementioned rounded portions the same, the tip can have a spherical surface.

Uniform loading of the spring is achieved if the ramps are straight. For example, the ramps can be at an angle alpha and/or beta of 30° to 60° to the longitudinal direction relative to the direction of travel. The loading of the spring can be varied as desired if the ramps are not straight but slightly curved.

On the other side of the latching arrangement, on the counter-latching member, the latching cam can likewise have a different geometry in order to enable the “feel” when actuating the sliding door to be matched to a large extent to the customer's requirements. For instance, the latching cam can have an entry ramp and a holding ramp and a tip region situated between them, the tip region can be designed as a straight line in the direction of travel of the sliding door, and the straight tip region can merge into the ramps via rounded portions. Fine coordination of the forces involved in latching is possible by coordinating the shape and height of the cam, i.e. its tip region, its ramps and its rounded portions.

Moreover, the entry ramp can be at a smaller angle to the direction of travel than the holding ramp, the angle gamma between the direction of travel and the entry ramp preferably being 10° to 20° and the angle delta between the direction of travel and the holding ramp preferably being 30° to 60° .

To gain momentum for releasing the latching arrangement when the sliding door is open, the holding ramp is adjoined by a traversing section extending in the direction of travel. Through the use of this traversing section, the latching of the nose on the holding arm by the holding force applied to the spring in addition to the preloading is fully assured. However, the run-up of the sliding door across this traversing section allows the holding ramp to be overcome more effectively. To brake the nose and hence the sliding door in the direction of maximum opening of the sliding door, the traversing section is adjoined by a raised portion, which can comprise a ramp. The raised portion does not have to serve as an end stop for the sliding door if a customary separate stop designed to withstand an appropriate loading is provided at some other point on the sliding door and its guide.

In order to keep the holding arm as compact as possible, despite the high spring force, the nose is supported on the holder via a compression spring, and the holding arm is designed as a two-armed lever, which is mounted pivotably in a holder. Provision is preferably made for the two-armed lever to have a short lever arm and a long lever arm, for the long lever arm to be supported on the holder via the compression spring, and for the short lever arm to be supported directly on the holder and hence to preload the compression spring.

The holding arm can preferably be mounted in a bent sheet-metal part if the holder accommodates the two-armed lever between two tabs bent in a U shape and holds it firmly in a pivotable manner using a pin that passes through the tabs and the lever. The bent sheet-metal part can be shaped in such a way that the holder has two angled tabs, on the connecting web of which, which is reinforced by a longitudinal bead or a welded-on angle piece, the compression spring is supported, and a further angled tab, on which the short lever arm is supported. For fixing, the holder can have at least one angled tab with means for the releasable fastening of the holder. These means can comprise a screw fastening, such as screws, or corresponding holes, nuts, threaded holes or the like.

If the holding arm or at least its nose and/or the latching cam comprises an abrasion-resistant plastic with good sliding properties, there is only little rubbing noise and only little wear.

### BRIEF DESCRIPTION OF THE DRAWINGS

An exemplary embodiment is illustrated in the drawing and will now be described in greater detail.

FIG. 1 shows a perspective view of a door catch in an installation position in the region of a running rail arranged on the body.

FIG. 2 shows a plan view of the door catch shown in FIG. 1.

FIG. 3 shows a perspective view of a holder for a holding arm.

FIG. 4 shows a perspective view of a holding arm of the door catch.

FIG. 5 shows a plan view of the holding arm shown in FIG. 4.

FIG. 6 shows the section VI-VI in FIG. 5 on an enlarged scale.

FIG. 7 shows a perspective view of a latching cam with its holder.

FIG. 8 shows the latching cam in a plan view of its installation position on a greatly enlarged scale.

### DETAILED DESCRIPTION OF PREFFERED EMBODIMENTS

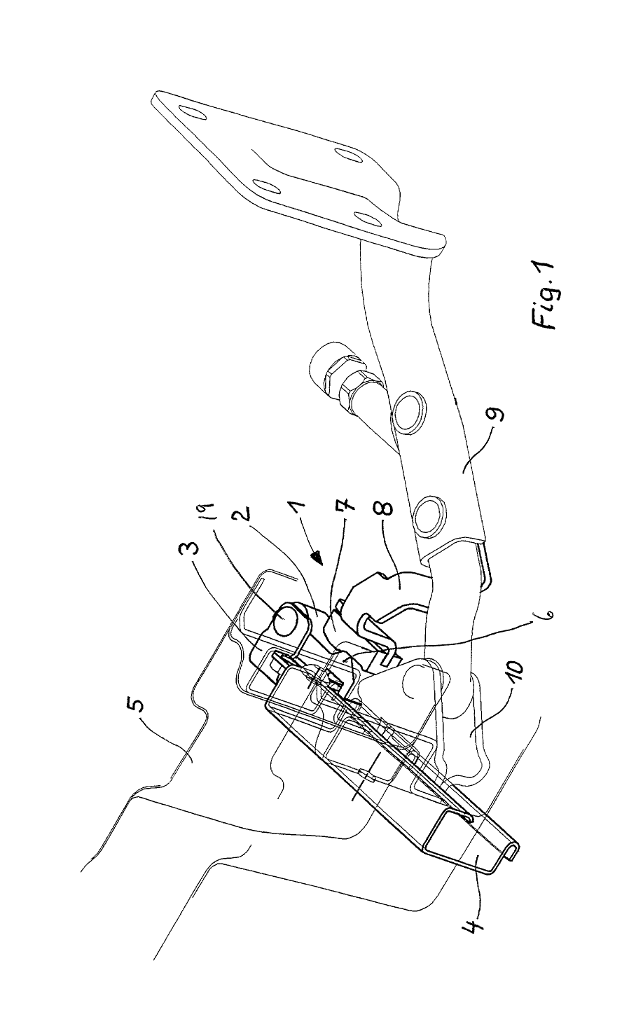

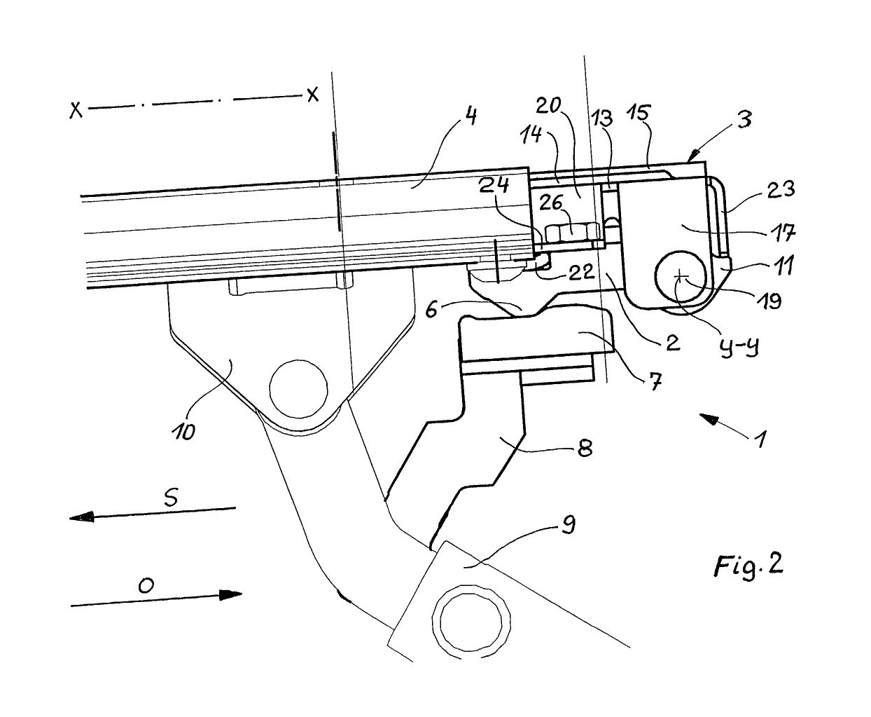

As shown in FIGS. 1 and 2, the door catch 1 comprises a holding arm 2, which is mounted pivotably in a holder 3. The holder 3 is secured at the rear end of a running rail 4, which is connected to the body 5.

The holding arm 2 interacts through an integrally formed nose 6 with a latching cam 7, which acts as a counter-latching member, to produce a locking effect. For this purpose, the latching cam 7 is connected indirectly, namely via a traveling carriage arm 9, to a sliding door via a holder 8 (See FIGS. 1, 2 and 7). The traveling carriage arm 9 connects the sliding door to the running rail 4 via a pivotably connected traveling carriage 10. The traveling carriage 10 is of known construction and guides the sliding door into the open or closed position during its displacement on the body. The direction or principal direction of travel of the sliding door is denoted by X-X. The door catch 1 exerts a locking action between the sliding door and the body 5 in this direction once the sliding door has reached its envisaged open end position.

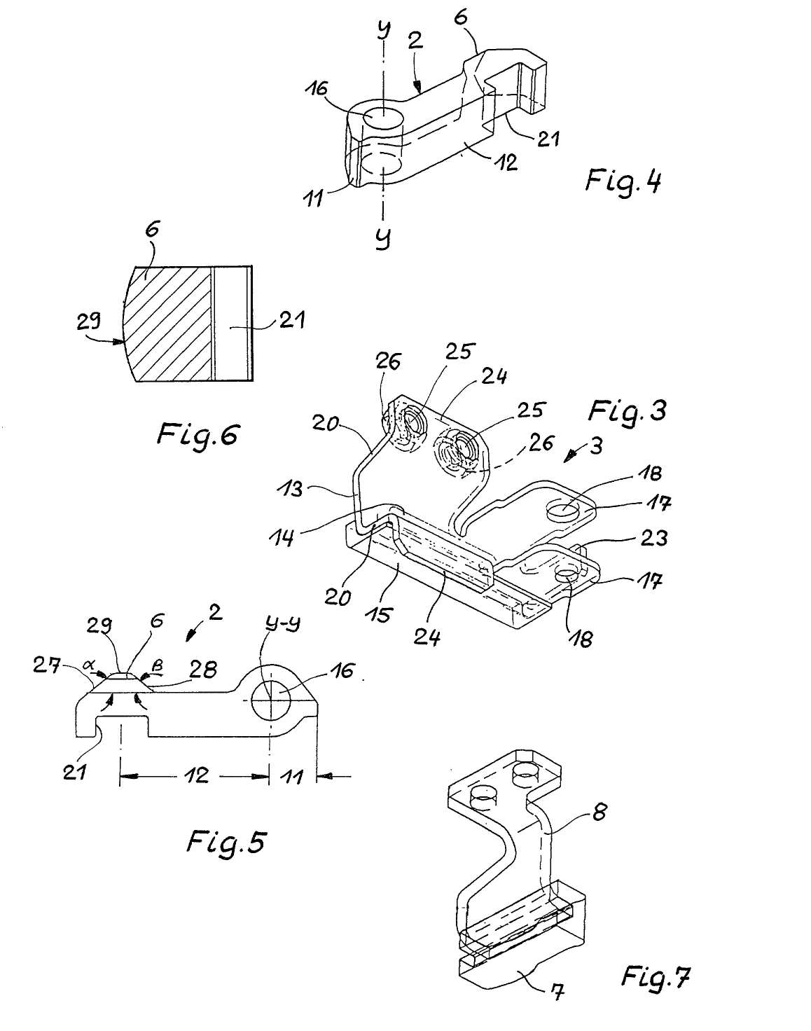

The holding arm 2 is designed as a two-armed lever, with a short lever arm 11 and a lever arm 12, which is about three to four times longer. The holder 3 is essentially bent in a U shape from a sheet-metal part (FIG. 3). It comprises a connecting web 13 extending over its entire length, which has an outward-arching bead 14 and a welded-on angle piece 15 to reinforce it. For the purpose of mounting the holding arm 2, it is provided with a through hole 16 between the lever arms 11 and 12. To form a U shape, two tabs 17 are formed on the connecting web 13 of the holder 3.

As shown in FIG. 3, holes 18 are introduced into the tabs 17, the holding arm 2 thus being held pivotably in the holder 3 with the aid of a pin 19, which passes through the through hole 16 and the holes 18. The pivoting axis Y-Y of the pin 19 and hence of the holding arm 2 and the nose 6 extends perpendicularly to the direction of travel X-X of the sliding door.

In addition to the tabs 17, two further tabs 20 are first of all bent out at a right angle, and the long lever arm 12 of the holding arm 2, on which the nose 6 is formed, extends between these tabs 20. As shown in FIGS. 4, 5 and 6, behind the nose 6, lever arm 12 is provided with a recess 21, which accommodates the end of a compression spring 22 (see FIG. 2). The other end of the compression spring 22 is supported against the connecting web 13.

In order to bring the compression spring 22 to its preloading force of, for example, 150 newtons and to keep it there, a lateral tab 23 (FIG. 2) is formed on the connecting web 13 and bent out at right angles. After the compression of the compression spring 22 to its preloading force, the short lever arm 11 is supported on the angled tab 23: the compression spring 22 is caught between the long lever arm 12 of the holding arm 2, on the one hand, and the connecting web 13 of the holder 3, on the other. Formed on the angled tabs 20 are two angle pieces 24, which extend approximately parallel to the connecting web 13. Two holes 25 are introduced into one angle piece 24, and two nuts 26 are welded on. These are used to screw the holder 3 onto the running rail 4.

The nose 6, or even the entire holding arm 2, and the latching cam 7 are composed of an abrasion-resistant plastic with good sliding properties, e.g. a plastic filled with carbon fibers, as sold under the trade name ZYTEL. The nose 6 and the latching cam 7 have special surfaces, which interact with one another and will now be described in greater detail with respect to FIGS. 5 and 6.

As shown in FIG. 5, nose 6 comprises two straight ramps 27 and 28, which can have the same angle of inclination alpha and beta respectively of between 30° and 60° . Here, 45° has been chosen for alpha and beta. Ramp 27, the entry ramp, extends somewhat further down than ramp 28 and forms the free end of the long lever arm 12. Ramp 28 forms the holding ramp, which interacts with the latching cam 7 in the open position of the sliding door and falls back to the level of the lever arm 12. The ramps 27 and 28 merge into one another at a tip 29, which is rounded in the direction of the ramps 27 and 28. A vertex of the tip 29 always extends transversely to the direction of travel X-X, in this case perpendicularly. However, it can also be horizontal or assume any desired angle in between if this is required by the installation conditions. The tip 29 can even be formed without a pronounced vertex, e.g. as a spherical surface.

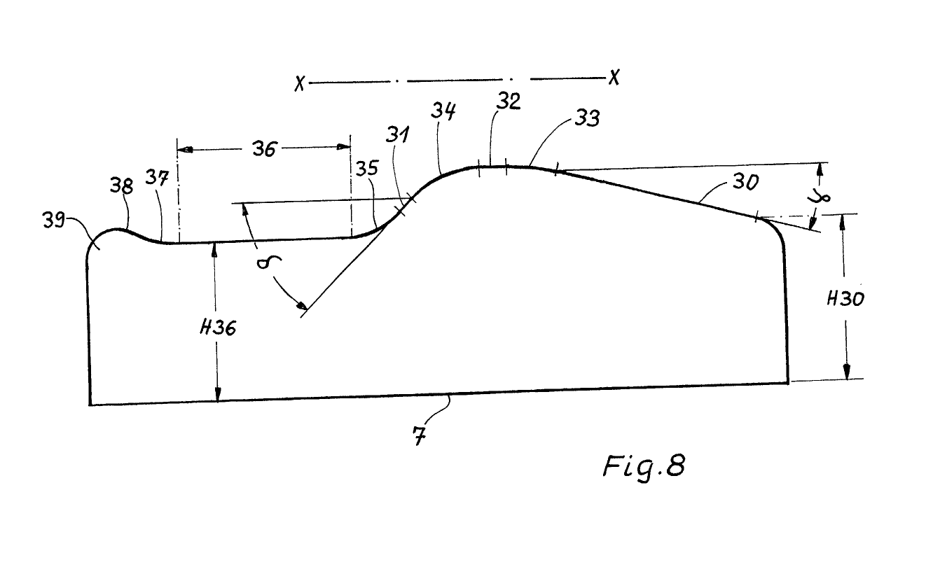

The latching cam 7 is illustrated on an enlarged scale in FIG. 8. It comprises an entry ramp 30, which is rounded toward the front, starts at the level H 30 and is at an angle gamma of about 15°, and a holding ramp 31 at an angle delta of about 45°. The intermediate tip region 32 is designed as a flat surface that extends in the direction of travel X-X. The tip region 32 merges into the ramps 30 and 31 via rounded portions 33 and 34. Adjoining the holding ramp 31, via another rounded portion 35, is a traversing section 36, which extends in the direction of travel X-X and is at the level H 36. Level H 36 corresponds approximately to level H 30. The traversing section 36 ends via a rounded portion 37 and a ramp 38 with a raised portion 39, which represents the end of the latching cam 7.

The door catch 1 operates as follows:

In the open position of the sliding door (the locking position), which is illustrated in FIG. 2, the nose 6 rests against the traversing section 36 and the ramp 31 of the latching cam 7 under only light pressure, if any. To close the sliding door in closing direction S, the sliding door and, together with it, the latching cam 7, is pushed somewhat further in opening direction O until the ramp 27 of the nose 6 strikes against the ramp 38 of the raised portion 39 and the end stop (not shown) of the sliding door is acted upon. The traversing section 36 has thus been used to the full.

The sliding door, and with it the latching cam 7, is now pushed in the closing direction S. During this process, the traversing section 36 of the latching cam 7 slides over the nose 6 without any significant resistance, and the sliding door—and the latching cam—acquire a certain momentum. This momentum helps the nose 6 to overcome the slope delta of the holding ramp 31, the rounded portion and the tip region 32 during further displacement in the closing direction S. This is because, as the nose 6 slides over said sliding areas, the load on the already preloaded compression spring 22 is increased further, namely from about 150 newtons to about 375 newtons. Via the tip 29 of the nose 6, the spring force acts on said sliding areas of the latching cam 7, with the peak value being in the tip region 32. During further displacement in the closing direction S, the nose 6 slides over the falling ramp 30, thus relieving the load on the compression spring 22 continuously until the nose 6 is released at the end of the ramp 30. The latching members 6 and 7 of the door catch 1 are now free of one another and there are no longer any frictional forces of the door catch 1. The sliding door can now finally be pushed into its closed position.

Owing to the abovementioned geometry and the lever action produced due to the abovementioned design and mounting of the holding arm, however, the forces that need to be applied when actuating the sliding door are at an acceptable level of about 120 newtons for closure and about 105 newtons for opening.

The force for opening and pushing the sliding door into its locked open position is lower, firstly because the sliding door initially travels a considerably longer distance without a braking action from the door catch 1 in the opening direction O and hence achieves a higher momentum, and secondly because the nose 6 can more readily overcome the gentler slope of the entry ramp 30 denoted by the angle gamma.

What is claimed is:

1. A door catch for a sliding door of a motor vehicle, comprising:
a holding arm, said holding arm being secured on a running rail of the sliding door by a holder and being pivotable against a preloaded spring;
a latching member, said latching member being a nose arranged on the holding arm, and
a counter-latching member, said counter-latching member being a latching cam acting transversely to a direction of travel of the sliding door,
wherein, in an open position of the door, said holding arm latches with said counter-latching member using said latching member.

2. The door catch as claimed in claim 1, wherein the nose has two ramps and a tip situated between them.

3. The door catch as claimed in claim 2, wherein the tip is rounded in a direction of the ramps.

4. The door catch as claimed in claim 3, wherein the tip is also rounded transversely to the direction of travel.

5. The door catch as claimed in claim 4, wherein the tip has a spherical surface.

6. The door catch as claimed in claim 2, wherein the ramps are straight.

7. The door catch as claimed in claim 6, wherein the ramps are at an angle of 30° to 60° to the direction of travel.

8. The door catch as claimed in claim 2, wherein the ramps are curved.

9. The door catch as claimed in claim 1, wherein the latching cam has an entry ramp and a holding ramp, and a tip region situated between the entry ramp and the holding ramp.

10. The door catch as claimed in claim 9, wherein the tip region is designed as a straight line in the direction of travel.

11. The door catch as claimed in claim 9, wherein the tip region merges into the entry ramp and the holding ramp via rounded portions.

12. The door catch as claimed in claim 9, wherein the entry ramp is at a smaller angle to the direction of travel than the holding ramp.

13. The door catch as claimed in claim 9, wherein an angle between the direction of travel and the entry ramp is 10° to 20° .

14. The door catch as claimed in claim 9, wherein an angle between the direction of travel and the holding ramp is 30° to 60° .

15. The door catch as claimed in claim 9, wherein the holding ramp is adjoined by a traversing section extending in the direction of travel.

16. The door catch as claimed in claim 15, wherein the traversing section is adjoined by a raised portion.

17. The door catch as claimed in claim 16, wherein the raised portion comprises a ramp.

18. The door catch as claimed in claim 1, wherein the nose is supported on the holder via a compression spring.

19. The door catch as claimed in claim 1, wherein the holding arm is a two-armed lever mounted pivotably in the holder.

20. The door catch as claimed in claim 19, wherein the two-armed lever has a short lever arm and a long lever arm, the long lever arm being supported on the holder via a compression spring, and the short lever arm being supported directly on the holder to preload the compression spring.

21. The door catch as claimed in claim 19, wherein the holder accommodates the two-armed lever between two tabs bent in a U shape and holds the two-armed lever in a pivotable manner by a pin passing through the tabs and the lever.

22. The door catch as claimed in claims 19, wherein the holder has two angled tabs and a connecting web, a compression spring being supported on the connecting web.

23. The door catch as claimed in claim 22, wherein the connecting web has at least one of a bead extending in a longitudinal direction and a reinforcing angle piece.

24. The door catch as claimed in claim 20, wherein the holder has an angled tab, on which the short lever arm is supported.

25 The door catch as claimed in claim 19, wherein the holder has at least one angled tab permitting releasable fastening of the holder.

26. The door catch as claimed in claim 1, wherein at least one of the holding arm, the nose and the latching cam comprises an abrasion-resistant slidable plastic.
